(19) United States
(12) Patent Application Publication
(10) Pub. No.: US 2026/0064762 A1
(43) Pub. Date: Mar. 5, 2026

(54) IMAGE RETRIEVAL METHOD, ELECTRONIC DEVICE AND NON-TRANSITORY COMPUTER-READABLE STORAGE MEDIUM

(71) Applicant: Beijing Zitiao Network Technology Co., Ltd., Beijing (CN)

(72) Inventors: Gonglei SHI, Beijing (CN); Yutao CHENG, Beijing (CN); Maoke YANG, Beijing (CN); Zhao ZHANG, Beijing (CN)

(21) Appl. No.: 19/316,515

(22) Filed: Sep. 2, 2025

(30) Foreign Application Priority Data
Sep. 2, 2024 (CN) 202411223836.8

(51) Int. Cl. G06F 16/532

(52) U.S. Cl. CPC G06F 16/532

(57) ABSTRACT

The present disclosure relates to an image retrieval method, an electronic device, and non-transitory computer-readable storage medium. The method includes: obtaining retrieval reference information, where the retrieval reference information includes first semantic information and first pixel information; based on the first semantic information, retrieving from a preset semantic information library and obtaining multiple candidate semantic information that match the first semantic information; based on candidate sample images to which the multiple candidate semantic information respectively belong, retrieving from a preset pixel information library and obtaining candidate pixel information corresponding to each of the multiple candidate sample images; according to a similarity between the candidate pixel information corresponding to each of the multiple candidate sample images and the first pixel information, selecting a target sample image from the multiple candidate sample images, and taking the target sample image as a retrieval result image corresponding to the retrieval reference information.

### CROSS-REFERENCE TO RELATED APPLICATION

This application claims the priority to and benefits of the Chinese Patent Application No. 202411223836.8, which was filed on Sep. 2, 2024. The aforementioned patent application is hereby incorporated by reference in its entirety.

### TECHNICAL FIELD

The present disclosure relates to an image retrieval method, an electronic device and a non-transitory computer-readable storage medium.

### BACKGROUND

In the creation of images such as posters, suitable material compositions are often required to highlight the theme of the image or to make the image more aesthetically pleasing. However, retrieving the required image materials is a rather difficult task, often requiring a high labor cost. The traditional image retrieval methods are ineffective, and the retrieved images are difficult to meet users'requirements.

### SUMMARY

In order to solve the above technical problems or at least partially solve the above technical problems, the present disclosure provides an image retrieval method, an electronic device, and a non-transitory computer-readable medium.

An embodiment of the present disclosure provides an image retrieval method. The method includes: obtaining retrieval reference information, where the retrieval reference information includes first semantic information and first pixel information; based on the first semantic information, retrieving from a preset semantic information library and obtaining multiple candidate semantic information that match the first semantic information, where the semantic information library contains semantic information of multiple sample images; based on multiple candidate sample images to which the multiple candidate semantic information respectively belong, retrieving from a preset pixel information library and obtaining candidate pixel information corresponding to each of the multiple candidate sample images, where the pixel information library contains pixel information of the multiple sample images; according to a similarity between the candidate pixel information corresponding to each of the multiple candidate sample images and the first pixel information, selecting a target sample image from the multiple candidate sample images, and taking the target sample image as a retrieval result image corresponding to the retrieval reference information.

Optionally, the obtaining the retrieval reference information, includes: obtaining a first reference image; performing semantic feature extraction on the first reference image and obtaining the first semantic information; and performing pixel feature extraction on the first reference image and obtaining the first pixel information.

Optionally, the obtaining the first reference image, includes: obtaining a target reference image; obtaining an image corresponding to a material contained in the target reference image, and taking the image corresponding to the material as the first reference image.

Optionally, multiple materials are contained in the target reference image, and the method further includes: based on position information and layer information of the multiple materials in the target reference image, performing combination processing on retrieval result images corresponding to the multiple materials and obtaining a matching image corresponding to the target reference image.

Optionally, the performing the semantic feature extraction on the first reference image and obtaining the first semantic information, includes: performing the semantic feature extraction on the first reference image and obtaining a first semantic feature; taking the first semantic feature as the first semantic information; alternatively, obtaining a quantization feature corresponding to the first semantic feature based on a preset quantization semantic codebook and obtaining the first semantic information based on the quantization feature corresponding to the first semantic feature.

Optionally, the performing the pixel feature extraction on the first reference image and obtaining the first pixel information, includes: performing the pixel feature extraction on the first reference image and obtaining a first pixel feature; and taking the first pixel feature as the first pixel information; alternatively, obtaining a quantization feature corresponding to the first pixel feature based on a preset quantization pixel codebook, and obtaining the first pixel information based on the quantization feature corresponding to the first pixel feature.

Optionally, the obtaining the retrieval reference information, includes: obtaining retrieval prompt information; and based on the retrieval prompt information, generating the first semantic information and the first pixel information by using a preset generation model.

Optionally, based on the retrieval prompt information, the generating the first semantic information and the first pixel information by using the preset generation model, includes: based on the retrieval prompt information, generating a first semantic feature flag sequence and a first pixel feature flag sequence by using the preset generation model; obtaining a quantization feature corresponding to the first semantic feature flag sequence based on a preset quantization semantic codebook, and taking the quantization features corresponding to the first semantic feature flag sequence as the first semantic information; and obtaining a quantization feature corresponding to the first pixel feature flag sequence based on a preset quantization pixel codebook, and taking the quantization features corresponding to the first pixel feature flag sequence as the first pixel information.

Optionally, the retrieving from the preset semantic information library and obtaining the multiple candidate semantic information that match the first semantic information, includes: arranging similarities between the first semantic information and semantic information in the preset semantic information library in order of magnitude, and selecting top N pieces of semantic information with a highest similarity as the multiple candidate semantic information that match the first semantic information, where N is a preset positive integer greater than one; alternatively, taking semantic information in the preset semantic information library whose similarity to the first semantic information is higher than a preset threshold, as multiple candidate semantic information that match the first semantic information.

Embodiments of the present disclosure also provide an image retrieval apparatus. including: an information obtaining module configured to obtain retrieval reference information, where the retrieval reference information includes first semantic information and first pixel information; a first retrieval module, configured to retrieve from a preset semantic information library based on the first semantic information, and obtain multiple candidate semantic information that match the first semantic information, where the semantic information library contains semantic information of multiple sample images; a second retrieval module, configured to retrieve from a preset pixel information library based on multiple candidate sample images to which the multiple candidate semantic information respectively belong, and obtain candidate pixel information corresponding to each of the multiple candidate sample images, where the pixel information library contains pixel information of the multiple sample images; a result obtaining module, configured to select a target sample image from the multiple candidate sample images according to a similarity between the candidate pixel information corresponding to each of the multiple candidate sample images and the first pixel information, and take the target sample image as a retrieval result image corresponding to the retrieval reference information.

An embodiment of the present disclosure also provides an electronic device, which includes: a processor; and a memory for storing the processor executable instructions. The processor is configured to read the executable instructions from the memory and execute the instructions to implement the image retrieval method as provided by the embodiments of the present disclosure.

Embodiments of the present disclosure also provide a computer-readable storage medium. The storage medium stores computer program, and the computer program is used to execute the image retrieval method as provided by the embodiments of the present disclosure.

It should be understood that the content described in this section is not intended to identify key or important features of the embodiments of the present disclosure, nor is it used to limit the scope of the present disclosure. Other features of the present disclosure will become readily understood from the following description.

### BRIEF DESCRIPTION OF DRAWINGS

The accompanying drawings, which are incorporated in and constitute a part of this specification, illustrate embodiments consistent with the disclosure and together with the description, serve to explain the principles of the disclosure.

In order to more clearly explain the embodiments of the present disclosure or the technical solutions in the prior art, the drawings needed to be used in the description of the embodiments or the prior art will be briefly introduced below. Obviously, for those of ordinary skill in the art, other drawings may also be obtained based on these drawings without exerting creative effort.

FIG. 1 is a schematic flowchart of an image retrieval method according to an embodiment of the present disclosure;

FIG. 2 is a schematic diagram of an image retrieval system according to an embodiment of the present disclosure;

FIG. 3 is a schematic diagram of an image retrieval process according to an embodiment of the present disclosure;

FIG. 4 is a schematic diagram of an image retrieval process according to an embodiment of the present disclosure;

FIG. 5 is a schematic diagram of an image processing according to an embodiment of the present disclosure;

FIG. 6 is a schematic structural diagram of an image retrieval apparatus according to an embodiment of the present disclosure;

FIG. 7 is a schematic structural diagram of an electronic device according to an embodiment of the present disclosure.

### DETAILED DESCRIPTION

In order that the above objects, features and advantages of the present disclosure may be more clearly understood, aspects of the present disclosure will be further described below. It should be noted that the embodiments of the present disclosure and the features in the embodiments may be combined with each other without conflict.

In the following description, numerous specific details are set forth in order to provide a thorough understanding of the disclosure, but the disclosure may be practiced otherwise than as described herein. Obviously, the embodiments in the specification are only some, not all, of the embodiments of the present disclosure.

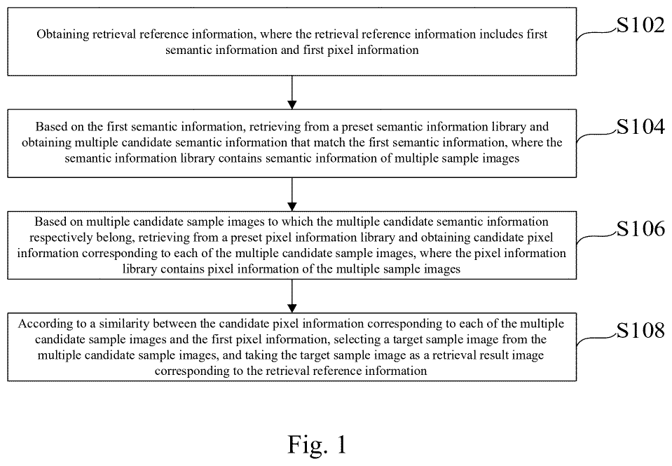

FIG. 1 is a schematic flowchart of an image retrieval method according to an embodiment of the present disclosure. The method may be executed by an image retrieval apparatus, where the apparatus may be implemented by software and/or hardware, and may generally be integrated in an electronic device. As shown in FIG. 1, the method mainly includes the following steps S102 to S108.

At step S102, retrieval reference information is obtained. The retrieval reference information includes first semantic information and first pixel information. The embodiments of the present disclosure do not limit the form of the first semantic information and the first pixel information. For example, the first semantic information and the first pixel information may be semantic content and image content, or semantic feature and pixel feature, or processed features of semantic feature and pixel features, such as semantic quantization features and pixel quantization features. In addition, the embodiments of the present disclosure do not limit the method of obtaining the retrieval reference information. For example, it may be the retrieval reference information directly input by the user, or it may be the retrieval reference information obtained by semantic feature or pixel feature extraction based on the image input by the user. It may also be retrieval reference information generated by the generation model based on prompt information input by the user.

At step S104, based on the first semantic information, a retrieval is carried out from a preset semantic information library and multiple candidate semantic information that match the first semantic information are obtained. The semantic information library contains semantic information of the multiple sample images.

The similarities between the plurality of candidate semantic information and the first semantic information are higher than the similarity between the non-candidate semantic information in the semantic information library and the first semantic information. In some implementations, the similarities between the first semantic information and semantic information in the preset semantic information library may be arranged in order of magnitude, and the top N pieces of semantic information with the highest similarity may be selected as the multiple candidate semantic information matching the first semantic information. N is a preset positive integer greater than one. Alternatively, semantic information in the preset semantic information library whose similarity to the first semantic information is higher than a preset threshold is taken as multiple candidate semantic information matching the first semantic information. In practical applications, the value of N and the preset threshold of similarity may be flexibly set according to needs, and are not limited here. In addition, the semantic information database may contain the semantic information of a large number of sample images, and the sample images are the images in the sample image library. Specifically, embodiments of the present disclosure may obtain the semantic information of all sample images in the existing sample image library, thereby obtaining the semantic information library. The embodiments of the present disclosure do not limit the calculation method of the similarity between features. In practical applications, matrix multiplication and other methods may be used to perform matrix multiplication on the first semantic information and the semantic information library, thereby obtaining the similarity between the first semantic information and the semantic information in the semantic information library, and then selecting the candidate semantic information based on the level of similarity.

At step S106, based on candidate sample images to which the multiple candidate semantic information respectively belong, a retrieval is carried out from a preset pixel information library and obtain candidate pixel information corresponding to each of multiple candidate sample images. The pixel information library contains pixel information of the multiple sample images.

The sample image to which multiple candidate semantic information belongs is the candidate sample image. Embodiments of the present disclosure may obtain the pixel information of all sample images in the aforementioned existing sample image library, thereby obtaining a pixel information library. The embodiment of the present disclosure first selects the candidate sample images through semantic retrieval, and then directly searches the image information corresponding to the candidate sample images from the pixel information library, that is, the candidate pixel information.

At step S108, a target sample image is selected from the multiple candidate sample images according to a similarity between the candidate pixel information corresponding to each of the multiple candidate sample images and the first sample image information, and the target sample image is taken as a retrieval result image corresponding to the retrieval reference information. The number of target sample images may be one or more.

In practical applications, the similarities between the candidate pixel information corresponding to each of the multiple candidate sample images and the first pixel information are arranged according to the magnitude, the candidate sample images to which the top M candidate pixel information with the highest similarities belong are selected as the target sample images, and M is a preset positive integer that may be flexibly set according to needs. Through the above method, the retrieval result images whose semantic and pixel features both match the retrieval reference information may be selected from all the sample images contained in the sample image library.

The above technical solution according to the embodiments of the present disclosure does not require manual labor and time-consuming and labor-intensive image retrieval. Instead, it may first obtain the retrieval reference information in two dimensions, namely the first semantic information and the first pixel information. Then, based on the first semantic information and the first pixel information, the semantic information library (containing semantic information of multiple sample images) and the pixel information library (containing pixel information of multiple sample images) are successively used for semantic information retrieval and pixel information retrieval. This retrieval method may effectively ensure that the retrieved target sample images meets the requirements in terms of the semantic level and the image pixel level. Moreover, the staged retrieval method may also retrieve images that meet the requirements more efficiently, comprehensively ensuring that the retrieval results meet the requirements and retrieval efficiency.

In some embodiments, the above steps of obtaining the retrieval reference information may be performed with reference to the following steps A to C.

At step A, the first reference image is obtained.

In some specific implementation examples, the first reference image may be the entire image input by the user. In other specific implementation examples, a target reference image may be obtained first, and then an image corresponding to material contained in the target reference image may be obtained, and the image corresponding to the material may be taken as the first reference image. The embodiments of the present disclosure do not limit the content contained in the target reference image. For example, the target reference image may be a poster, an advertisement page, etc., and may specifically be an image input by the user. Different from the traditional image search by image technology, the embodiments of the present disclosure do not directly perform image retrieval on the entire target reference image. Instead, retrieval may be carried out respectively for the materials contained in the target reference image that the user wishes to retrieve, and sample images similar to that materials are obtained. The materials contained the target reference image include but are not limited to the background image, stickers, content, etc. Any element contained in the target reference image may be used as a material. Specifically, the materials contained in the target reference image may be obtained through methods such as layer recognition and object recognition, so as to obtain the image corresponding to the materials, and the image corresponding to each material may be respectively taken as the first reference image, so that images similar to each material may be retrieved respectively.

At step B, semantic feature extraction is performed on the first reference image and obtain the first semantic information. In some specific implementation examples, the step B was carried out with reference to the following steps B1 and B2.

At step B1, the semantic feature extraction is performed on the first reference image and the first semantic feature is obtained.

In order to ensure the accuracy of the semantic feature, exemplarily, a semantic feature visual encoder may be used to extract semantic features from the first reference image. For example, a supervised approach may be used to obtain a semantic feature visual encoder with strong semantic coding capabilities. Then, four-channel semantic coding is performed through the semantic feature visual encoder to obtain a relatively accurate and reliable first semantic features. In addition, the embodiments of the present disclosure do not limit the implementation manner of the semantic feature visual encoder.

At step B2, the first semantic feature is taken as the first semantic information. Alternatively, the quantized feature corresponding to the first semantic feature is obtained based on a preset quantization semantic codebook, and the first semantic information is obtained based on the quantized feature corresponding to the first semantic feature. In practical applications, the continuous first semantic features may be directly taken as the first semantic information, or the quantization semantic codebook may be configured to match the first semantic features with the most approximate features in the quantization semantic codebook, thereby discretizing the continuous features to be suitable for subsequent different data processing modes. The above-mentioned quantization semantic codebook is mainly a codebook designed for a specific semantic feature and is configured to quantize these features. It may finally generate the required quantization semantic codebook through model training and other methods based on a large amount of sample data. The quantization semantic codebook may be used to quantize the semantic features to the closest features in the codebook, which helps to simplify and compress the data while maintaining the expression of the basic features of the data. The principle and obtaining method of the quantization semantic codebook may refer to related technologies and will not be described here. In practical applications, semantic feature or semantic quantized features may be flexibly selected as the first semantic information to be retrieved according to requirements, and with no limitation posed thereon.

At step C, a pixel feature extraction is performed on the first reference image and the first pixel information is obtained. In some specific implementation examples, the step C may be performed with reference to the following steps C1 and C2.

At step C1, the pixel feature extraction is performed on the first reference image to obtain the first pixel features.

In order to ensure the accuracy of the pixel features, exemplarily, a pixel feature visual encoder may be used to extract pixel features from the first reference image. In some specific implementation examples, the size of the first reference image may be adjusted to obtain an image with a specified size.

Then, the feature visual encoder pixel is used to perform down sampling on the image with the specified size by a specified multiple, that is, to perform reconstruct encoding on the image with the specified size, thereby obtaining the first pixel features. For example, as the 4×4 pixel features obtained through down sampling may be taken as the first pixel features, and these features may also be called fuzzy features or rough features. By means of rough feature extraction, images that are similar to but not exactly the same as the first reference image may be retrieved based on these features subsequently, so as to avoid affecting the user experience by providing the retrieval result image that is exactly the same as the input target reference image. In addition, the embodiments of the present disclosure do not limit the implementation manner of the pixel feature visual encoder.

At step C2, the first pixel featured may be taken as the first pixel information; Alternatively, the quantization feature corresponding to the first pixel feature is obtained based on a preset quantization pixel codebook, and the first pixel information is obtained based on the quantization feature corresponding to the first pixel feature. In practical applications, the continuous first pixel features may be directly taken as the first pixel information, or the quantization pixel codebook may be configured to match the first pixel features with the most approximate features in the quantization pixel codebook, thereby discretizing the continuous features to be suitable for subsequent different data processing modes. The principle and obtaining method of the above-mentioned quantization pixel codebook is similar to those of the quantization semantic codebook, and thus for details, reference may be made to related technologies, which will not be described here. In practical applications, pixel features or pixel quantization features may be flexibly selected as the first pixel information to be retrieved according to requirements, which will not be limited here.

Through the above method, retrieval reference information in two dimensions, the first semantic information and the first pixel information, may be obtained accurately and reliably.

In some embodiments, the above steps of obtaining the retrieval reference information may be performed with reference to the following steps a to b.

At step a, the retrieval prompt information is obtained, and the retrieval prompt information may specifically include the retrieval prompt input by the user, which may be configured to describe the theme style or the content information contained in the image that it is desired to retrieve.

At step b, based on the retrieval prompt information, the first semantic information and the first pixel information are generated by using a preset generation model. The embodiments of the present disclosure do not limit the implementation of the generation model. For example, the generation model may be a large language model. Considering the characteristic that the generation model is more convenient for generating discretized data, in some specific implementation examples, step b may be executed with reference to the following steps b1 to b3.

At step b1, a first semantic feature flag sequence and a first pixel feature flag sequence may be generated by using a preset generation model. Among them, the first semantic feature flag sequence may also be called the first semantic feature token sequence, and the first pixel feature flag sequence may also be called the first semantic feature token sequence, where token specifically refers to a discrete language flag.

At step b2, quantization features corresponding to the first semantic feature flag sequence are obtained based on a preset quantization semantic codebook, and the quantization features corresponding to the first semantic feature flag sequence are taken as the first semantic information; and based on the first semantic feature flag sequence, the quantization feature corresponding to the token may be searched from the quantization semantic codebook, thereby obtaining the first semantic information.

At step b3, quantization features corresponding to the first pixel feature flag sequence is obtained based on a preset quantization pixel codebook, and the quantization features corresponding to the first pixel feature flag sequence are taken as the first pixel information. Based on the first pixel feature flag sequence, the quantization features corresponding to the token may be searched from the quantization pixel codebook, thereby obtaining the first semantic information.

Through the above method, retrieval reference information containing two dimensions of semantic and pixel features may be intelligently generated by directly generating the model without users using complex language descriptions. On this basis, the semantic information database and the pixel information database may be used to perform two-stage retrieval to obtain the retrieval result image whose semantic and pixel features both meet the requirements.

In practical applications, the above image retrieval method according to the embodiments of the present disclosure may retrieve new images based on existing images.

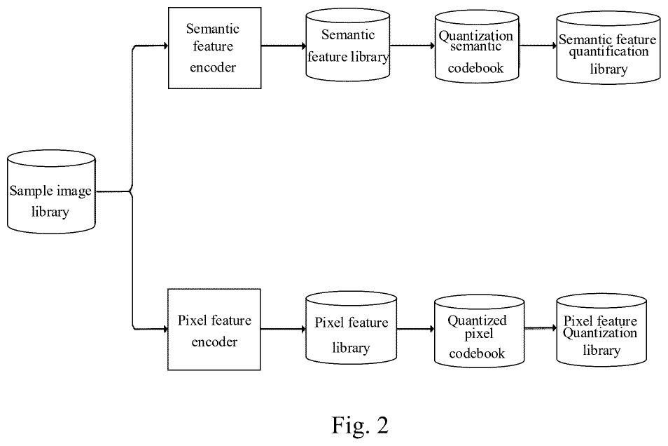

For ease of understanding, refer to the schematic diagram of an image retrieval system shown in FIG. 2. The image retrieval system includes a sample image library, and the sample image library contains a large number of existing sample images. In related technologies, image retrieval is typically performed directly based on the sample image library. However, in the embodiment of the present disclosure, semantic feature encoders and pixel feature encoders are used to extract features from all images in the sample image library, thereby constructing a semantic feature library and a pixel feature library. Furthermore, considering that generation models such as large language models usually generate discrete data, for example discrete language flag sequences corresponding to semantic or pixel features, to this end, embodiments of the present disclosure may also use a quantization semantic codebook and a quantization pixel codebook to construct and generate a quantization semantic feature library and a quantization pixel feature library, respectively. This facilitates subsequent retrieval in the quantization library based on the information generated by the model. In practical applications, not only the semantic and pixel feature library may be used as the semantic information library and pixel feature library, but also the quantization semantic feature library and the quantization pixel feature library may be used as the semantic information library and pixel feature library, without any limitation.

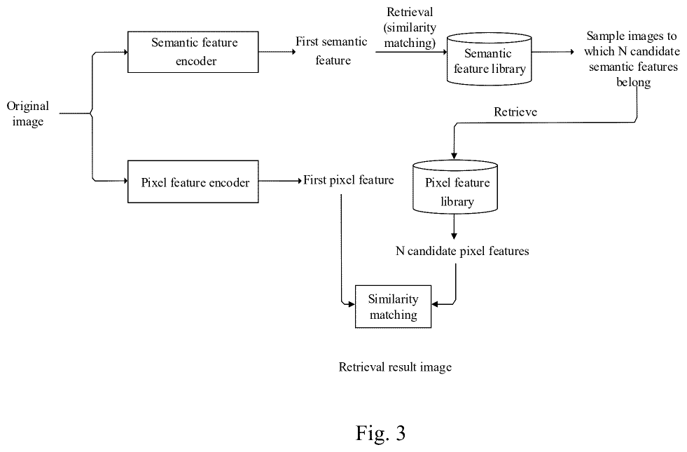

Based on the foregoing, an embodiment of the present disclosure provides a schematic image retrieval process as shown in FIG. 3. FIG. 3 schematically illustrates the image retrieval process based on the first semantic information and the first pixel information extracted from the existing image (original image). In FIG. 3, the original image may include either the target reference image input by the user or the image corresponding to the material contained in the target reference image, with the aim of retrieving images that are semantically similar and have similar pixel features to the original image, but are not exactly the same. In the embodiment of the present disclosure, the semantic feature encoder and the pixel feature encoder may be used to respectively extract the first semantic features and the first pixel features. The first semantic features are matched for similarity with the semantic features contained in the semantic feature library, thereby retrieving the top N candidate semantic features with the highest similarity in the semantic feature library. Then, based on the sample images (candidate sample image) to which the N candidate semantic features belong, N candidate pixel features are retrieved from the pixel feature library. The candidate pixel features are pixel features belonging to the candidate sample images. Then, by performing similarity matching between the first pixel features and N candidate pixel features, a specified number of target pixel features may be obtained according to the magnitude of the similarity. The candidate sample images to which the target pixel features belong are the target sample images, that is, the retrieval result images.

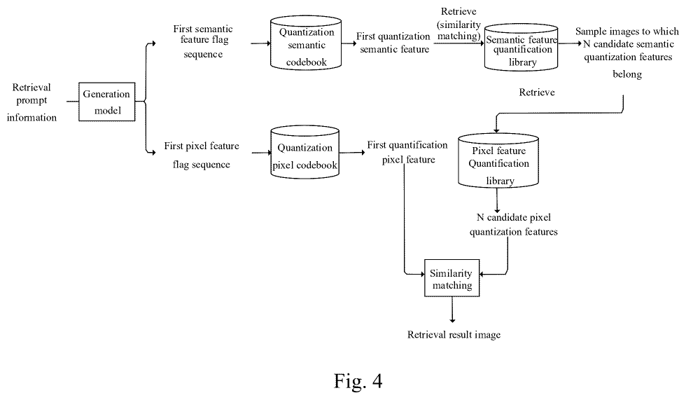

The embodiment of the present disclosure also provides a schematic diagram of an image retrieval process as shown in FIG. 4. FIG. 4 schematically illustrates a method of performing image retrieval based on the generation model generating the first semantic information and the first pixel information. In FIG. 4, the first semantic information and the first pixel information generated by the generation model are the first quantization semantic features and the first quantization pixel features, and the semantic information library and the pixel information library are the semantic feature quantization library and the pixel feature quantization library, respectively. It may be understood that the generation model such as large language models are better at generating discrete data, such as generating feature flag sequences. Therefore, in the embodiment of the present disclosure, the flag sequence generated by the generation model may be first converted into quantization features through corresponding quantization codebooks, and then retrieval is performed in the quantization library. The subsequent retrieval method is similar to that in FIG. 3 and will not be repeated here. It should be noted that compared with the method in the related art that directly uses the generation model to generate material images, the above method according to the embodiments of the present disclosure is more reliable. Specifically, the method of directly using the generation model to generate images is uncontrollable, and it is difficult to ensure that the images generated by the model meet the requirements. Moreover, the model may even generate bad examples, thereby affecting the user experience. In contrast, in the embodiments of the present disclosure, there already have an sample image library with guaranteed quality, and then based on the retrieval reference information generated by the generation model, the retrieval result images that meet the requirements may be retrieved from the sample image. This method is more controllable and may fully ensure the quality of the final retrieval result images.

In addition, it should be noted that in practical applications, FIGS. 3 and 4 may also be combined. For example, in order to facilitate processing, the semantic feature quantization library and the pixel feature quantization library may be uniformly used as the semantic information library and the pixel information library. For the continuous semantic features and pixel features obtained by performing feature extraction from the original image in FIG. 3, they may also be further converted into the first quantization semantic features and the first quantization pixel features through the quantization semantic codebooks and the quantization pixel codebooks, so as to align with the retrieval method using generation models. This will not be illustrated here.

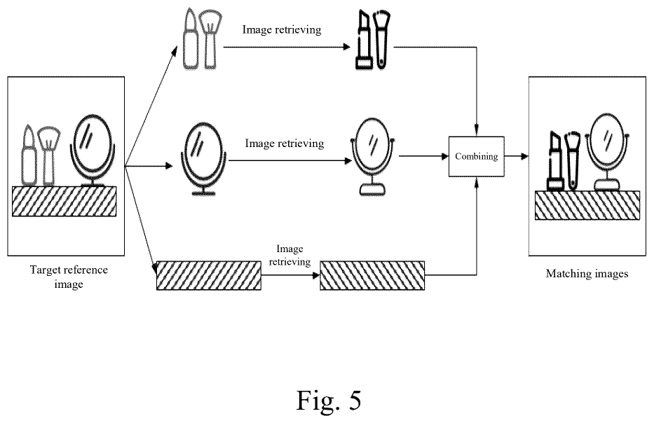

Furthermore, as mentioned above, the retrieval may be performed directly based on the target reference image input by the user, or based on the image corresponding to the material contained in the target reference image input by the user. In the case of the latter, when the target reference image contains multiple materials, the method according to the embodiment of the present disclosure further includes: performing a combination process on the retrieval result images corresponding to the multiple materials based on position information and layer information of the multiple materials in the target reference image, and obtaining a matching image corresponding to the target reference image. In this way, it may be fully ensured that the finally obtained image may achieve sematic and pixel feature matching at the material granularity with the target reference image input by the user. For ease of understanding, refer to the schematic diagram of image processing shown in FIG. 5. For a target reference image containing three materials, namely a makeup brush, a makeup mirror, and a table for holding the makeup brush and the makeup mirror, the aforementioned method may be respectively adopted to perform retrieval for each material, so as to obtain the retrieval result images that match each material in terms of semantic and pixel features. Subsequently, by performing combination processing on the retrieval result images corresponding to each material, a matching image that is similar to each material in the target reference image may be obtained, comprehensively meeting the retrieval requirements of the user.

It may be understood that in related technologies, image retrieval is mostly carried out by using an image to search for other images or by using text to search for other images. For the image-based image retrieval method, it is very likely that the original image or a part of the original image will be directly searched out, rather than the images containing variants as expected by the user. As for the text-based image retrieval method, the retrieved images will only meet the semantic requirements, making it difficult to satisfy the user's requirements. For poster creators, it is very difficult to retrieve and obtain a complete set of materials required in the poster, which will take a lot of time and effort. For example, it is also difficult to describe the required materials through concise natural language. However, by adopting the method provided in the embodiments of the present disclosure, two-stage image retrieval may be carried out by using the selected features (first semantic information and first pixel information), so as to efficiently and reliably obtain images whose semantic features and pixel features both meet the requirements but are not exactly the same. In specific applications, retrieval may be carried out for all the materials in an existing image (such as a finished poster), so as to obtain a complete set of replacement materials whose semantic and pixel features are similar to those of the materials in the existing image but are not exactly the same. Alternatively, a generation model such as a large language model may be directly used to generate a set of required material resources based on the retrieval prompt information, that is, to simultaneously meet the feature compatibility and semantic adaptability of the retrieved materials, so as to better meet the user's requirements and comprehensively ensure the reliability and efficiency of image retrieval.

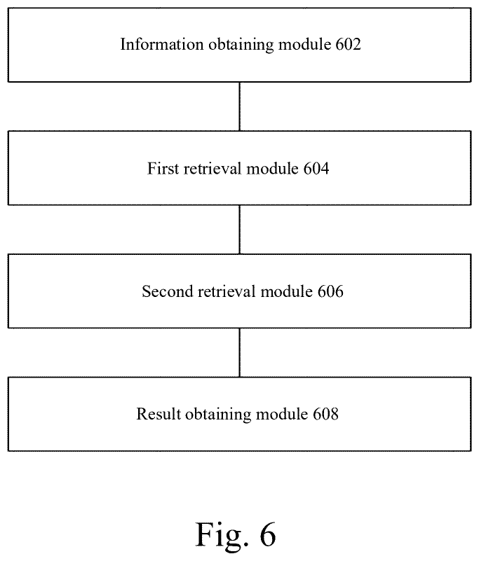

Corresponding to the aforementioned image retrieval method, embodiments of the present disclosure further provide an image retrieval apparatus. FIG. 6 is a schematic structural diagram of an image retrieval apparatus according to an embodiment of the present disclosure. This apparatus may be implemented by software and/or hardware, and may generally be integrated into the electronic device. As shown in FIG. 6, the image retrieval apparatus includes an information obtaining module 602, a first retrieval module 604, a second retrieval module 606 and a result obtaining module 608.

The information obtaining module 602 is configured to obtain retrieval reference information. The retrieval reference information includes the first semantic information and the first pixel information.

The first retrieval module 604 is configured to perform a retrieval from a preset semantic information library based on the first semantic information to obtain multiple candidate semantic information matching the first semantic information. The semantic information library contains semantic information of multiple sample image.

The second retrieval module 606 is configured to perform a retrieval in a preset pixel information library based on the candidate sample images to which the multiple candidate semantic information respectively belong, and obtain candidate pixel information corresponding to each of the multiple candidate sample image. The pixel information library contains pixel information of the multiple sample image.

The result obtaining module 608 is configured to select a target sample image from the multiple candidate sample images according to the similarity between the candidate pixel information corresponding to each of the multiple candidate sample images and the first sample image information, and take the target sample image as the retrieval result image corresponding to the retrieval reference information.

The above technical solution according to the embodiments of the present disclosure does not require manual labor and time-consuming and labor-intensive image retrieval. Instead, it may first obtain the retrieval reference information in two dimensions, namely the first semantic information and the first pixel information. Then, based on the first semantic information and the first pixel information, the semantic information library (containing semantic information of multiple sample images) and the pixel information library (containing pixel information of multiple sample images) are successively used for semantic information retrieval and pixel information retrieval. This retrieval method may effectively ensure that the retrieved target sample images meet the requirements in terms of the semantic level and the image pixel level. Moreover, the staged retrieval method may also retrieve images that meet the requirements more efficiently, comprehensively ensuring that the retrieval results meet the requirements and retrieval efficiency.

In some implementations, the information obtaining module 602 is specifically configured to obtain the first reference image, perform semantic feature extraction on the first reference image to obtain a first semantic information and perform pixel feature extraction on the first reference image to obtain first pixel information.

In some implementations, the information obtaining module 602 is specifically configured to obtain target reference image, obtain an image corresponding to materials contained in the target reference image, and take the image corresponding to the materials as the first reference image.

In some embodiments, when the target reference image includes multiple materials, the apparatus further includes a combination module. The combination module is configured to combine, based on the position information and layer information of the multiple materials in the target reference image, the retrieval result images corresponding to the multiple materials to obtain a matching image corresponding to the target reference image.

In some embodiments, the information obtaining module 602 is specifically configured to:

perform semantic feature extraction on the first reference image to obtain a first semantic features and take the first semantic feature as first semantic information; alternatively, obtain quantization features corresponding to the first semantic features based on a preset quantization semantic codebook, and take the quantization features corresponding to the first semantic features as first semantic information.

In some embodiments, the information obtaining module 602 is specifically configured to: perform pixel feature extraction on the first reference image to obtain first pixel feature, and take the first pixel feature as first pixel information; alternatively, obtain quantization features corresponding to the first pixel features based on the preset quantization pixel codebooks and obtain the first pixel information based on the quantization features corresponding to the first pixel features.

In some implementations, the information obtaining module 602 is specifically configured to obtain a retrieval prompt information and generate the first semantic information and the first pixel information based on the retrieval prompt information.

In some embodiments, the information obtaining module 602 is specifically configured to: generate a first semantic feature flag sequence and a first pixel feature flag sequence using a preset generation model based on the retrieval prompt information; obtain quantization features corresponding to the first semantic feature flag sequence based on a preset quantization semantic codebook, and take the quantization features corresponding to the first semantic feature flag sequence as the first semantic information; and obtain quantization features corresponding to the first pixel feature flag sequence based on a preset quantization pixel codebook, and take the quantization features corresponding to the first pixel feature flag sequence as the first pixel information.

In some implementations, the first retrieval module 604 is specifically configured to: arrange the similarity between the first semantic information and semantic information in the preset semantic information library in order of magnitude, and select the top N pieces of semantic information with the highest similarity as multiple candidate semantic information matching the first semantic information. N is a preset positive integer greater than one. Alternatively, semantic information in the preset semantic information library whose similarity to the first semantic information is higher than a preset threshold is taken as multiple candidate semantic information that matches the first semantic information.

The image retrieval apparatus according to the embodiments of the present disclosure may execute the image retrieval method according to any embodiment of the present disclosure, and has functional modules and beneficial effects corresponding to the execution of the method.

Those skilled in the art may clearly understand that for the convenience and concise of description, the specific working process of the apparatus embodiment described above may refer to the corresponding process in the method embodiment, and will not be described here.

An embodiment of the present disclosure provides an electronic device. The electronic device includes: a storage apparatus on which computer program is stored; and a processing device, configured to execute the computer program in the storage apparatus to implement the steps of any method in the present disclosure.

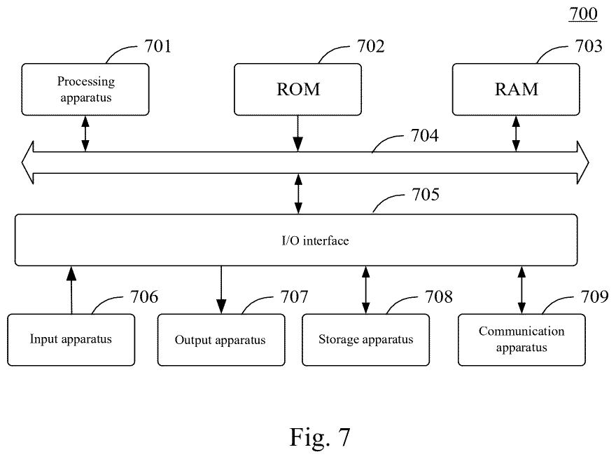

Referring to FIG. 7, FIG. 7 illustrates a schematic structural diagram of an electronic device 700 suitable for implementing some embodiments of the present disclosure. The terminal devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal) or the like, and fixed terminals such as a digital TV, a desktop computer, or the like. The electronic device illustrated in FIG. 7 is merely an example, and should not pose any limitation to the functions and the range of use of the embodiments of the present disclosure.

As illustrated in FIG. 7, the electronic device 700 may include a processing apparatus 701 (e.g., a central processing unit, a graphics processing unit, etc.), which can perform various suitable actions and processing according to a program stored in a read-only memory (ROM) 702 or a program loaded from a storage apparatus 708 into a random-access memory (RAM) 703. The RAM 703 further stores various programs and data required for operations of the electronic device 700. The processing apparatus 701, the ROM 702, and the RAM 703 are interconnected by means of a bus 704. An input/output (I/O) interface 705 is also connected to the bus 704.

Usually, the following apparatus may be connected to the I/O interface 705: an input apparatus 706 including, for example, a touch screen, a touch pad, a keyboard, a mouse, a camera, a microphone, an accelerometer, a gyroscope, or the like; an output apparatus 707 including, for example, a liquid crystal display (LCD), a loudspeaker, a vibrator, or the like; a storage apparatus 708 including, for example, a magnetic tape, a hard disk, or the like; and a communication apparatus 709. The communication apparatus 709 may allow the electronic device 700 to be in wireless or wired communication with other devices to exchange data. While FIG. 7 illustrates the electronic device 700 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 709 and installed, or may be installed from the storage apparatus 708, or may be installed from the ROM 702. When the computer program is executed by the processing apparatus 701, the above-mentioned functions defined in the methods of some embodiments of the present disclosure are performed.

In addition to the above method and device, an embodiment of the present disclosure may also provide a computer program product, including computer program instructions which, when executed by a processor, cause the processor to perform the image processing method according to the embodiment of the present disclosure. The computer program product may write program codes for performing the operations of the embodiments of the present disclosure in any combination of one or more programming languages, including object-oriented programming languages such as Java, C++, and conventional procedural programming languages such as “C” or similar programming languages. The program codes may be completely executed on a user computing device, partially executed on the user device, executed as an independent software package, partially executed on the user computing device and partially executed on the remote computing device, or completely executed on the remote computing device or a server.

In addition, an embodiment of the present disclosure may also provide a computer-readable storage medium having stored thereon computer program instructions which, when executed by a processor, cause the processor to execute the image retrieval method according to the embodiment of the present disclosure.

The computer-readable storage medium may adopt any combination of one or more readable medium. The readable medium may be a readable signal medium or a readable storage medium. The readable storage medium may include, for example, but not limited to, an electrical, magnetic, optical, electromagnetic, infrared, or semiconductor system, apparatus or device, or a combination of any of the above. More specific examples (a non-exhaustive list) of the readable storage medium include: an electrical connection with one or more wires, a portable disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

An embodiment of the present disclosure also provides a computer program product, including computer programs/instructions, which, when executed by a processor, implement the image retrieval method in the embodiment of the present disclosure.

For example, when receiving an active request from a user, prompt information is sent to the user to explicitly prompt the user that an operation requested by the user will need to obtain and use the user's personal information. In this way, the user may choose whether to provide personal information to a software or hardware such as an electronic device, an application, a server, or a storage medium that performs the operation of the technical solution of the present disclosure according to the prompt information.

As an optional but non-limiting implementation, in response to receiving an active request from a user, the prompt information may be sent to the user in the form of a pop-up window, and the prompt message may be presented in the pop-up window in the form of text. In addition, the pop-up window may also carry a selection control for the user to select “agree” or “disagree” to provide personal information to the electronic device.

It may be understood that the above process of notifying and obtaining user authorization is only schematic, and does not limit the implementation of the present disclosure. Other manners that meet relevant laws and regulations may also be applied to the implementation of the present disclosure.

It is to be noted that the relationship terms, such as “first” and “second”, are used herein only for distinguishing one entity or operation from another entity or operation but do not necessarily require or imply that there exists any such actual relationship or sequence between these entities or operations. Also, the terms “comprise”, “include”, or any other variation thereof, are intended to cover a non-exclusive inclusion, such that a process, method, article, or device that includes a list of elements does not include only those elements but also may include other elements not expressly listed or inherent to such process, method, article, or device. Without further limitation, an element defined by the phrase “comprising an . . . ” does not exclude the presence of other identical elements in the process, method, article, or device that includes the element.

The previous description is only for the purpose of describing particular embodiments of the present disclosure, so as to enable those skilled in the art to understand or implement the present disclosure. Many modifications to these embodiments will be obvious to those skilled in the art, and the general principles defined herein may be implemented in other embodiments without departing from the spirit or scope of the present disclosure. Therefore, the present disclosure will not be limited to the embodiments described herein, but is to be accorded the widest scope consistent with the principles and novel features disclosed herein.

1. An image retrieval method, comprising:
obtaining retrieval reference information, wherein the retrieval reference information comprises first semantic information and first pixel information;
based on the first semantic information, retrieving from a preset semantic information library and obtaining multiple candidate semantic information that match the first semantic information, wherein the semantic information library contains semantic information of multiple sample images;
based on multiple candidate sample images to which the multiple candidate semantic information respectively belong, retrieving from a preset pixel information library and obtaining candidate pixel information corresponding to each of the multiple candidate sample images, wherein the pixel information library contains pixel information of the multiple sample images; and
according to a similarity between the candidate pixel information corresponding to each of the multiple candidate sample images and the first pixel information, selecting a target sample image from the multiple candidate sample images, and taking the target sample image as a retrieval result image corresponding to the retrieval reference information.

2. The image retrieval method of claim 1, wherein the obtaining the retrieval reference information, comprises:
obtaining a first reference image;
performing semantic feature extraction on the first reference image and obtaining the first semantic information; and performing pixel feature extraction on the first reference image and obtaining the first pixel information.

3. The image retrieval method of claim 2, wherein the obtaining the first reference image, comprises:
obtaining a target reference image; and
obtaining an image corresponding to a material contained in the target reference image, and taking the image corresponding to the material as the first reference image.

4. The image retrieval method of claim 3, wherein multiple materials are contained in the target reference image, and the image retrieval method further comprises:
based on position information and layer information of the multiple materials in the target reference image, performing combination processing on retrieval result images corresponding to the multiple materials and obtaining a matching image corresponding to the target reference image.

5. The image retrieval method of claim 2, wherein the performing the semantic feature extraction on the first reference image and obtaining the first semantic information, comprises:
performing the semantic feature extraction on the first reference image and obtaining a first semantic feature; and
taking the first semantic feature as the first semantic information.

6. The image retrieval method of claim 2, wherein the performing the semantic feature extraction on the first reference image and obtaining the first semantic information, comprises:
performing the semantic feature extraction on the first reference image and obtaining a first semantic feature; and
obtaining a quantization feature corresponding to the first semantic feature based on a preset quantization semantic codebook, and obtaining the first semantic information based on the quantization feature corresponding to the first semantic feature.

7. The image retrieval method of claim 2, wherein the performing the pixel feature extraction on the first reference image and obtaining the first pixel information, comprises:
performing the pixel feature extraction on the first reference image and obtaining a first pixel feature; and
taking the first pixel feature as the first pixel information.

8. The image retrieval method of claim 2, wherein the performing the pixel feature extraction on the first reference image and obtaining the first pixel information, comprises:
performing the pixel feature extraction on the first reference image and obtaining a first pixel feature; and
obtaining a quantization feature corresponding to the first pixel feature based on a preset quantization pixel codebook, and obtaining the first pixel information based on the quantization feature corresponding to the first pixel feature.

9. The image retrieval method of claim 1, wherein the obtaining the retrieval reference information, comprises:
obtaining retrieval prompt information; and
based on the retrieval prompt information, generating the first semantic information and the first pixel information by using a preset generation model.

10. The image retrieval method of claim 9, wherein based on the retrieval prompt information, generating the first semantic information and the first pixel information by using the preset generation model, comprises:
based on the retrieval prompt information, generating a first semantic feature flag sequence and a first pixel feature flag sequence by using a preset generation model;
obtaining a quantization feature corresponding to the first semantic feature flag sequence based on a preset quantization semantic codebook, and taking the quantization feature corresponding to the first semantic feature flag sequence as the first semantic information; and
obtaining a quantization feature corresponding to the first pixel feature flag sequence based on a preset quantization pixel codebook, and taking the quantization feature corresponding to the first pixel feature flag sequence as the first pixel information.

11. The image retrieval method of claim 1, wherein the retrieving from the preset semantic information library and obtaining the multiple candidate semantic information that match the first semantic information, comprises:
arranging similarities between the first semantic information and semantic information in the preset semantic information library in order of magnitude, and selecting top N pieces of semantic information with a highest similarity as the multiple candidate semantic information that match the first semantic information, wherein N is a preset positive integer greater than one.

12. The image retrieval method of claim 1, wherein the retrieving from the preset semantic information library and obtaining the multiple candidate semantic information that match the first semantic information, comprises:
taking semantic information in the preset semantic information library whose similarity to the first semantic information is higher than a preset threshold, as the multiple candidate semantic information that match the first semantic information.

13. An electronic device, comprising:
a storage apparatus, wherein a computer program is stored on the storage apparatus; and
a processing apparatus, configured to execute the computer program on the storage apparatus to implement an image retrieval method,
wherein the image retrieval method comprises:
obtaining retrieval reference information, wherein the retrieval reference information comprises first semantic information and first pixel information;
based on the first semantic information, retrieving from a preset semantic information library and obtaining multiple candidate semantic information that match the first semantic information, wherein the semantic information library contains semantic information of multiple sample images;
based on multiple candidate sample images to which the multiple candidate semantic information respectively belong, retrieving from a preset pixel information library and obtaining candidate pixel information corresponding to each of the multiple candidate sample images, wherein the pixel information library contains pixel information of the multiple sample images; and
according to a similarity between the candidate pixel information corresponding to each of the multiple candidate sample images and the first pixel information, selecting a target sample image from the multiple candidate sample images, and taking the target sample image as a retrieval result image corresponding to the retrieval reference information.

14. The electronic device of claim 13, wherein the obtaining the retrieval reference information, comprises:
obtaining a first reference image;
performing semantic feature extraction on the first reference image and obtaining the first semantic information; and performing pixel feature extraction on the first reference image and obtaining the first pixel information.

15. The electronic device of claim 14, wherein the obtaining the first reference image, comprises:
obtaining a target reference image; and
obtaining an image corresponding to a material contained in the target reference image, and taking the image corresponding to the material as the first reference image.

16. The electronic device of claim 15, wherein multiple materials are contained in the target reference image, the method further comprising:
based on position information and layer information of the multiple materials in the target reference image, performing combination processing on the retrieval result images corresponding to the multiple materials and obtaining a matching image corresponding to the target reference image.

17. The electronic device according to claim 14, wherein the performing the semantic feature extraction on the first reference image and obtaining the first semantic information, comprises:
performing the semantic feature extraction on the first reference image and obtaining a first semantic feature; and
taking the first semantic feature as the first semantic information.

18. The electronic device according to claim 14, wherein the performing the pixel feature extraction on the first reference image and obtaining the first pixel information, comprises:
performing the pixel feature extraction on the first reference image and obtaining a first pixel feature; and
taking the first pixel feature as the first pixel information.

19. The electronic device of claim 13, wherein the obtaining the retrieval reference information, comprises:
obtaining retrieval prompt information; and
based on the retrieval prompt information, generating the first semantic information and the first pixel information by using a preset generation model.

20. A non-transitory computer-readable storage medium, wherein the storage medium stores a computer program, the computer program is configured to execute an image retrieval method, and
the image retrieval method comprises:
obtaining retrieval reference information, wherein the retrieval reference information comprises first semantic information and first pixel information;
based on the first semantic information, retrieving from a preset semantic information library and obtaining multiple candidate semantic information that match the first semantic information, wherein the semantic information library contains semantic information of multiple sample images;
based on multiple candidate sample images to which the multiple candidate semantic information respectively belong, retrieving from a preset pixel information library and obtaining candidate pixel information corresponding to each of the multiple candidate sample images, wherein the pixel information library contains pixel information of the multiple sample images; and
according to a similarity between the candidate pixel information corresponding to each of the multiple candidate sample images and the first pixel information, selecting a target sample image from the multiple candidate sample images, and taking the target sample image as a retrieval result image corresponding to the retrieval reference information.
